(19) United States
(12) Patent Application Publication
(10) Pub. No.: US 2005/0216569 A1
(43) Pub. Date: Sep. 29, 2005

(54) Method for implementing content delivery network (cdn) internetworking, respective networks and interface component

(76) Inventors: Crescenzo Coppola, Torino (IT); Pier Luca Papagna, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/512,018

(22) PCT Filed: Apr. 17, 2003
(86) PCT No.: PCT/EP03/04059

§ 371 Date: May 24, 2005

(30) Foreign Application Priority Data
Apr. 19, 2002 (IT) TO2002A00341

(51) Int. Cl. G06F 15/167

(52) U.S. Cl. 709/213

(57) ABSTRACT

Internetworking of a set of Content Delivery Networks CDN (CDN1, CDN2) is obtained by employing interface components intended to be each associated to a network (CDN1) in the set and co-operating according to a Content Internetworking Gateway (CIG) another components association the set of said interface Services or Domain Name networks. Access of internetworking networks through the Directory Name Service or Domain Name Server (DNS) of the respective network. with at least one (CDN2) of the collect routing data referred similar component in set. Said interface to the them in transferred by Directory Name the respective the contents of network (CIG) of contents and caches which contain networks. The routing components (CIG) Servers clients (CDN1, CDN2) is thus implemented through the Directory Name Service or Domain Name Server (DNS) of the respective network.

### TECHNICAL FIELD

This invention relates in general to techniques generally known as “internetworking”.

In general terms, the basic objective of internetworking is the co-operation and interoperability of elementary systems (seen as “black boxes”) to create a macrosystem capable of presenting the characteristics of the constituent systems with the addition of a number of advantages.

### BACKGROUND ART

Firstly, when two or more different administrative entities reach an internetworking agreement they extend (within contractual limits) their respective catchment areas without additional expenses for wiring or structural purposes. It is reasonable to think that the service quality perceived by the final user may be increased due to the larger size of the reference network.

In the specific case of the so-called Content Delivery Networks, or CDNs, additional contents and diversification is also provided.

For its very nature, an internetworking solution requires the presence of interface components which, on elementary system (i.e. single CDN) side have a complete overview of the evolution of the static and dynamic characteristics and which on the “rest of the world” side (i.e. on the side of the other internetworking networks, that is on peer side) have only the comprehensive information needed to establish profitable intersystem communication. The term “profitable” here means efficient, safe and reliable being provided with the mechanisms that this type of solution entails.

Regulations concerning the matter are currently being drawn up, as documented, for example, by the following draft standards published by IETF (Internet Engineering Task Force) which can be retrieved from the organisation's web site, namely:
“A Model for CDN Peering”, by M. Day, B. Cain, G. Tomlinson and P. Rzewski, May 2001;
“Content Internetworking Architectural Overview”, by M. Green, B. Cain, G. Tomlinson, S. Thomas e P. Rzewski, March 2001;
“Known Mechanisms for Content Internetworking”, by F. Douglis, I. Chaudhri and P. Rzewski, November 2001.

The interface components are called Content Internetworking Gateways or CIGs. CIGs have a complete overview of the environment within their respective CDN and perceive the data related to remote environments through protocols for exchanging data, called “advertisements”.

From an abstract point of view, a CIG must route requests (i.e. perform request-routing functions), on the basis of all data from the pre-existing infra-CDN modules (distribution system and monitoring system) and equivalent remote devices.

According to the aforesaid standards, the CIG routes a client's content requests.

Specifically, having received a request for a certain content and having verified that the content is available in its respective CDN, the CIG sends the corresponding required content cache ID to the client. The concerned CIG is consequently capable of routing the request, also when the content is hosted in the cache of another CDN.

In this situation, when several CDN networks are internetworking, the CIGs perform address resolution and content request-routing functions, which on internet level are remitted to other network members, particularly by involving the so-called DNS (Directory Name Service or Domain Name Server).

This leads to splitting/duplication of functions which causes several problems. The problems are related, among other, to the need of ensuring correct synchronisation between CIGs and devices in the Internet and to the fact that the request from a certain client is processed differently according to whether the request involves the CDN level or not.

### DISCLOSURE OF THE INVENTION

The object of the invention is to overcome these shortcomings.

The object is obtained according to the invention thanks to a procedure whose characteristics are recited in the annexed claims. The invention also relates to a corresponding system of internetworking CDN networks and a respective interface or CIG component.

### BRIEF DESCRIPTION OF DRAWINGS

The invention will now be described, by way of example only, with reference to the accompanying drawings wherein:

FIG. 1 generally illustrates the internetworking organisation criteria of two CDN networks,

FIG. 2 generally illustrates the structures of a Content Internetworking Gateway, or CIG, according to the invention,

FIGS. 3 and 4 illustrate different infra-CDN and inter-CDN request-routing methods,

FIGS. 5 to 7 illustrate the typical CIG context diagrams at various levels detail according to the invention,

FIG. 8 shows the finite state automaton of a corresponding CIG,

FIG. 9 is a time diagram showing the opening of a corresponding session, and

FIGS. 10 to 13 illustrate the format of the various messages exchanged by a CIG according to the invention.

### BEST MODE FOR CARRYING OUT THE INVENTION

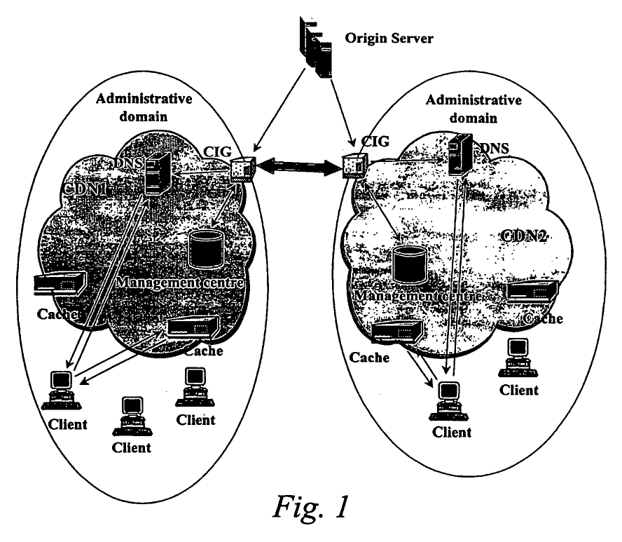

The diagram in FIG. 1 illustrates the collocation of two Content Internetworking Gateways (hereinafter called CIG for short) intended to permit exchange of “advertisement” data in the context of a set formed by two Content Delivery Networks CDN1 and CDN2 in combination with an Origin Server (OS) each.

Each CDN shown here consists of a respective administrative domain with a Directory Name Service or Domain Name Server (DNS for short), management centre, cache memories and connections to client function terminals.

FIG. 1 shows the role of the CIGs in the internetworking process. One of the specific characteristics of a CIG is the degree (or level) of integration, as a parameter, respect to the modules which are already present and operational within a CDN.

The higher or lower efficiency of the respective interface functions can be assessed according to this parameter.

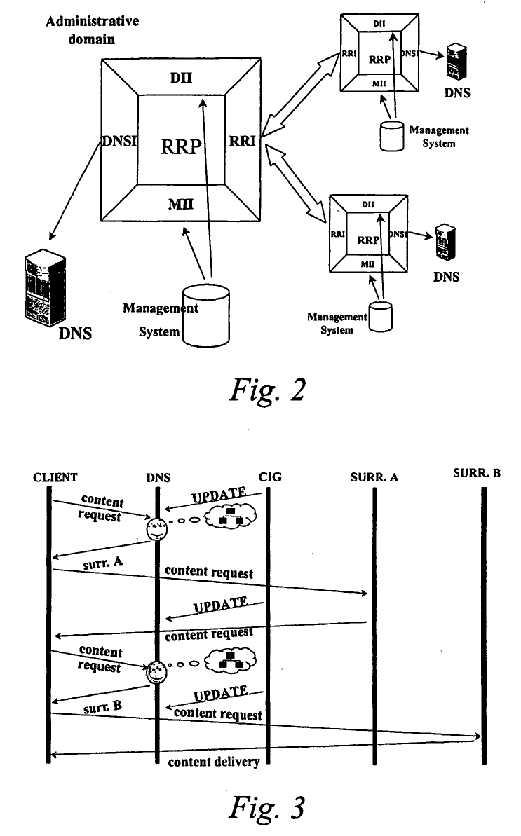

FIG. 2 briefly illustrates the interface components which form a CIG according to the invention in the currently preferred form of embodiment.

Specifically, the concerned CIG consists of:
a first interface module, called Request-Routing Interface or RRI, which exchanges data with the remote CIGs according to CNAP protocol specifications (described in detail in the description that follows),
a second interface module, called DNS Interface or DNSI, which interfaces with the DNS of the CDN to which the CIG belongs,
a third interface module, called Distribution Information Interface, or DII, which retrieves data on the availability of contents from the distribution system of the CDN to which the CIG belongs,
a forth interface module, called Monitoring Information Interface, or MII, which interacts with the monitoring system, and finally
a central module, called Request-Routing Process, or RRP, which collects and processes the information received to implement the request-routing function: the latter module is the CIG core.

It is noted that the aforesaid architecture, although preferred, is not absolutely imperative or binding, at least as concerns the presence of the third or fourth interface module described above.

Further reference to the CNAP protocol may be found in “Content Network Advertisement Protocol (CNAP)” by B. Cain, O. Spatscheck, L. Amini, A. Barbir, M. May and D. Kaplan, November 2001, which may also be retrieved from the IETF web site.

Briefly, the CIG consists of a central module which is the “brain” of the device and a certain number of interface modules between the CIG and the pre-existing infrastructure.

The described request-routing technique solution refers to modules implementing DNS technology.

Consequently, two likely internetworking scenarios may be hypothesised and illustrated in an event trace diagram.

FIG. 3 shows a classical content routing scenario, so to speak, the term herein indicating a standard routing process in a CDN (implementing DNS technology) in which DNS table updating is delegated to the CIG by means of the DNSI module.

Extending the example to an actual internetworking case is easy with this procedure.

The labels and the directions of the arrows in the figures help to understand the real sequence of events: a user makes a content request to the DNS system which works in standard mode. The DNS responds with the best surrogate IP address according to the routing policies applied at the time. The CIG periodically updates the DNS tables, according to the information received from the distribution and monitoring system; note that in this first case, the system is “isolated”, so to speak.

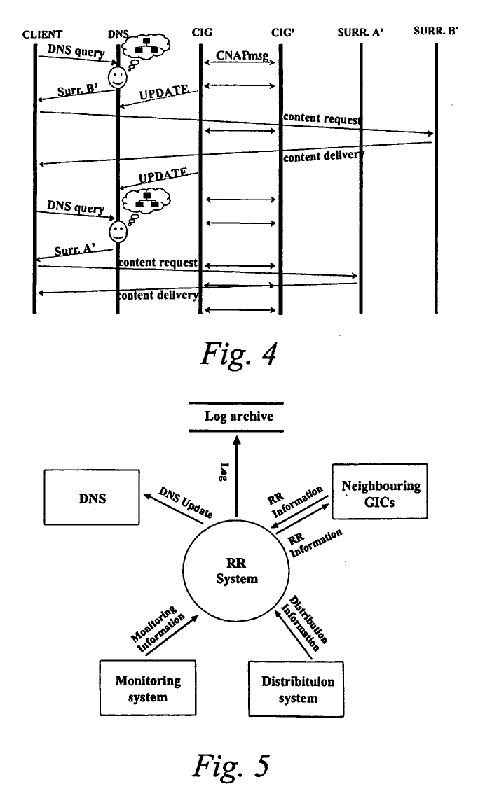

Conversely, in the situation in FIG. 4, the selected surrogate servers belong to another administrative domain, i.e. CDN. The dynamics appears essentially similar to the example above. In this case, as above, the client queries the DNS which replies with the best surrogate server IP address. The difference is in the data retrieving and updating method. The bi-directional arrows in the central section indicate the periodical exchange of routing data between entities on the same hierarchic level (peers), i.e. the CIGs, according to the conventions and the specifications of the CNAP protocol. This type of data is similar to infra-CDN data, and used by a CIG to update the DNS tables on the basis of a wider range of data with respect to that which occurs in known architectures.

The roles of the modules which form a CIG operating according to the invention will now be described with reference to the diagram indicated by the acronym DFD (Data Flow Diagram).

The higher level approach consists in the use of a so-called context diagram. The diagram represents the interactions between the whole CIG and the “outside world”. As shown, the CIG appears as a single entity capable of interacting with the rest of the world.

The CIG routes requests according to the information from the other entities with which it communicates. More in detail, it receives data from peers, from the distribution system and the local monitoring system. After processing, the data, the DNS tables and the log file archives are updated.

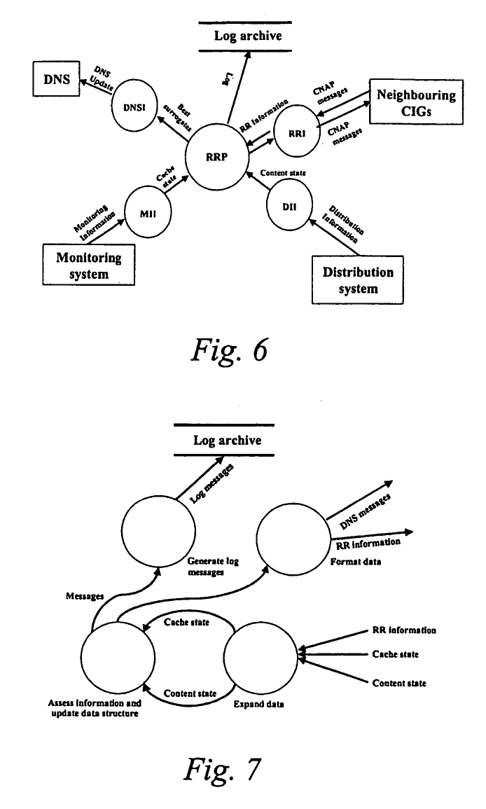

At this point, the request-routing system can be observed closer, by splitting into subsystems and representing the functions on different levels of detail. Two subsequent expansions are illustrated in FIG. 6 and FIG. 7, respectively.

Specifically, the interface processes clearly appear in FIG. 6, corresponding to a first level of detail: these are “buffer” modules which communicate with the central process on one side and with the outside world on the other.

FIG. 7, on the other hand, illustrates the functions of the RRP core. The RRP receives data from the rest of the world and transmits them via the interfaces, extracts useful information on cache and/or content state, evaluates the need to update and consequently modifies its own database, the DNS tables and the log file archives. Finally, if required, it sends the message to its peers, through the request-routing interface RRI.

The request-routing interface RRI interfaces with the rest of the world. From this point of view, it is the most important module in the internetworking procedure, because it is directly implied in inter-CDN communication; as mentioned above, this communication is carried out according to the conventions of the CNAP protocol which was designed for this purpose.

This module is responsible for translating the messages from CNAP (inter-CDN) format to a format which can be understood by the CIG (infra-CDN) central process, or RRP. The CNAP protocol requires initial specifications (and periodical updating) or a set of data, which are static so to speak, referred to the internetworking system topology characteristics. For example, the following may be requested:
the local CNAS ID (i.e. the CDN to which the concerned CIG belongs);
the IP address of the local CIG computer;
the CNAS IDs of remote interconnected systems (peers) with which internetworking will be established;
the IP addresses of the remote CIG computers corresponding to the systems mentioned in the point above;
the inter-CNAS level of confidences; and
a numeric coefficient indicating the “weight” in static conditions of each connection (practically similar to the geographical distance of the connection).

The protocol offers the possibility of diversifying the contractual internetworking relations with the introduction of level of confidences. In other words, before disseminating information on availability of a content to a remote CIG, the local CIG verifies whether the CIG is enabled to received the information according to the stipulated contact.

The CNAP connections, as required by the IETF for internetworking protocols, implement a reliable connection-oriented protocol on transportation level: for example, TCP (Transmission Control Protocol), currently employed in Internet contexts, may be used.

The logical operations needed to establish a CNAP session are shown below.

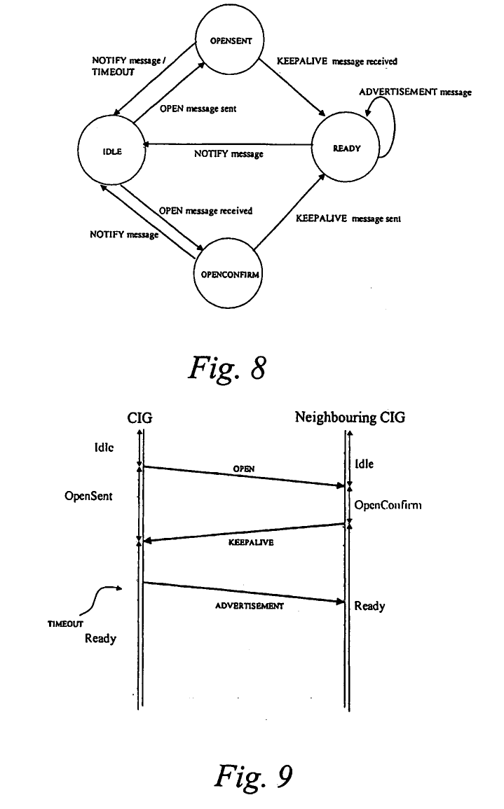

This is carried out with specific reference to the finite state automaton diagram of the CIG as illustrated in FIG. 8.

During the initial state of the CIG, called IDLE, there is no CNAP session and no entity has intervened to change this situation. When the CIG intends to establish a CNAP session with a remote CIG, it sends an OPEN message and goes to OPENSENT state.

The remote, also initially in IDLE state, receives a request to open a CNAP session. It replies with a KEEPALIVE message and goes to OPENCONFIRM state.

Two cases may occur.

In the first case, the original CIG receives the KEEPALIVE message within a predetermined lapse of time: in this case, it goes to READY state and waits to send advertisement messages (i.e. messages carrying useful data, not only metadata, as initialisation messages).

In the second case, the predetermined time-out expires before the original CIG receives the expected KEEPALIVE message: in this case, it returns to IDLE state and the communication attempt fails. In general, a NOTIFY message will inform the parties of the anomaly.

The remote CIG, having sent the following KEEPALIVE message, also goes to READY state and listens out for advertisement messages to be received.

The reception of a NOTIFY message makes the CIG go to IDLE state. As may easily be assumed from the description above, the CNAP connection is active and efficient if both involved CIG are in READY state.

FIG. 9 shows the sequences of state which characterise opening of a CNAP session and highlight the evolution of events in time.

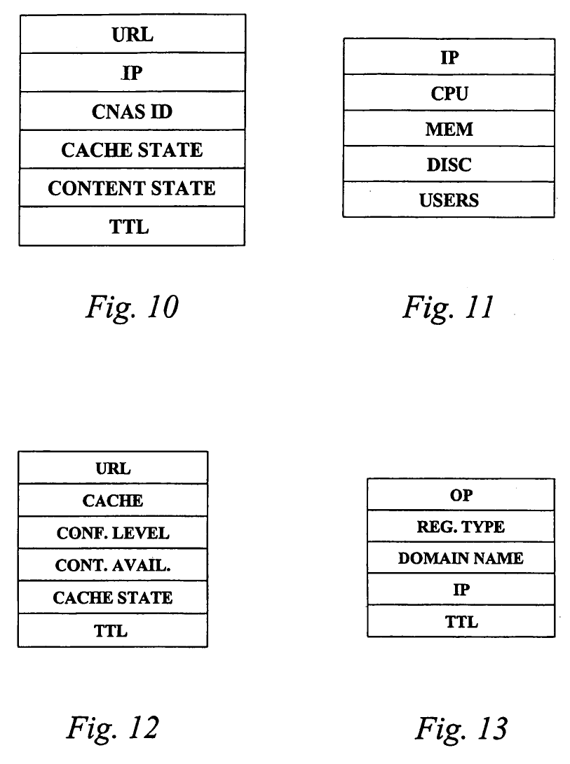

The messages exchanged by the RRP core and the request-routing interface RRI may have the format shown in FIG. 10.

The meaning of the message fields is shown below:
URL: is the URL identifying the content of the message;
IP: is the IP address of the cache which distributes the contents;
CNAS ID: is the ID of the CDN to which the cache belongs;
CACHE STATE: is the state of the cache;
CONTENT STATE: is the state of the content in the cache;
TTL: is the life time of the routing data.

The monitoring interface MII is the module which implements the interface between the RRP core and the local monitoring system, i.e. referred to the CDN to which the CIG belongs. The data which must be transferred to the RRP refer to the CDN cache state; the term “state” here indicates quantification of the available resources.

In this perspective, the format of a message from the monitoring interface MII may assume the appearance shown in FIG. 11.

The message has five fields whose meaning is illustrated below:
IP: the IP address of the cache to which the message refers;
CPU: percentage of CPU used by the cache;
MEM: percentage of RAM used by the cache;
DISC: percentage of disc used by the cache;
USERS: percentage of the number of connected users (in relation to the maximum service capacity of the concerned cache).

The parameters are classical performance indicators which are used to assess the conditions of use of the cache. Messages of this type are passed to the RRP at regular intervals of time.

The DII distribution interface is the interface module between the distribution system and the RRP core of the CIG. The DII interface collects information on the presence and availability of the cache contents. FIG. 12 shows the format of a possible message of this type.

The meaning of the fields is shown below:
URL: is the URL identifying the content to which the message refers;
CACHE: is the list of IP addresses of the caches in which the content is available;
LEVEL OF CONFIDENCE: is the level of confidence of the content;
CONTENT AVAILABILITY: indicates whether the content is available or not;
CACHE STATE: is the status of the cache;
TTL: indicates the life time of the routing data.

Three levels of confidence can be associated to the contents, i.e.:
low—contents can be exchanged with all interconnected CDNs;
medium—contents can be exchanged only with CDNs which have subscribed a MEDIUM level confidence agreement with the CDN that owns the content; and
high—contents can be exchanged only with CDNs which have subscribed a HIGH level confidence agreement with the CDN that owns the content.

The DNS interface, indicated by DNSI, is the interface module which must communicate with the DNS server, to update the tables. A possible format of the message useful for this purpose is shown in FIG. 13.

The meaning of the respective fields is:
OP: indicates the operation to be carried out on the DNS table (two operations are available, “add” and “delete”);
REG TYPE: indicates the type of register;
DOMAIN NAME: indicates the name of the domain to which the message refers;
IP: is the address of the best cache IP address to serve the domain above;
TTL: is the life time of the register.

Alternatively, the DOMAIN NAME field may contain the entire URL of the content to which the message refers. In this way, the DNS can directly identify the best cache for content delivery.

The request-routing module RRP is, as mentioned above, the core of the system. It is responsible for processing the data received from the aforesaid interface modules, updating the DNS tables if required via the DNSI interface and forwarding the data to the other CIGs through the RRI interface.

It is also responsible for managing the log file archive. Given the need to enable the respective DNS to perform the address resolution function (to make content delivery factually “transparent” with respect to the presence of a set of internetworking CDN networks), the RRP core must have a data structure which will store the states of the local CDN and the remote CDNs. The data structure must collect and organise the data referred to contents available in the internetworking system context and to the caches capable of providing the contents. Data structure definition is periodically updated by the RRP module, in a different way according to the type of message which prompted the updating process on a case-by-case basis.

Naturally, numerous changes can be implemented to the construction and embodiments of the invention herein envisaged without departing from the scope of the present invention, as defined by the following claims.

1. A method for implementing internetworking of a set of Content Delivery Networks CDN (CDN1, CDN2), the networks in said set being provided with respective caches, respective Directory Name Service or Domain Name Servers (DNS) and respective content distribution systems to respective clients, as well as interface components (CIG) susceptible of being each associated to a respective network (CDN1) in said set of networks and co-operating with at least one similar interface component (CIG) associated to another network (CDN2) in said set of networks, the method comprising the step of
collecting in said interface components (CIG) routing data related to the association of said contents and the caches which contain them;
transferring (DNSI) said routing data from at least one of said interface components (CIG) to the directory name service or domain name server (DNS) of the respective network, whereby access by the client of said respective network of contents of the networks in said set of CDN (CDN1, CDN2) is implemented through the Directory Name Service or Domain Name Server (DNS) of said network.

2. The method according to claim 1 wherein the following steps are performed by at least one of said interface components (CIG):
to receive data on the state of the cache and/or the contents of the respective network,
to determine whether said contents require an updating or not, and
to manage said updating by performing at least one step in the following group comprising:
editing the respective database,
editing the respective Directory Name Service tables, editing the respective log file archive, and
forwarding an update request message to said at least one similar component.

3. The method according to claim 2 wherein said interface components (CIG) communicate via a CNAP protocol.

4. A system comprising a set of internetworked Content Delivery Networks CDN (CDN1, CDN2), the networks in said set being provided with respective caches, respective Directory Name Service or Domain Name Server (DNS) and respective content distribution systems to respective clients, as well as interface components (CIG) susceptible of being each associated to a respective network (CDN1) in said set of networks and co-operating with at least one similar interface component associated to another network (CDN2) in said set of networks, said interface components (CIG) being configured to collect routing data related to the association of said contents and the caches which contain them, at least one of said interface components (CIG) being configured to transfer (DNSI) said routing data to the Directory Name Service or Domain Name Server (DNS) of the respective network, so that access by the client of said respective network to the contents of the networks in said set of CDN (CDN1, CDN2) is implemented through the Directory Name Service or Domain Name Server (DNS) of said network.

5. The system according to claim 4 wherein at least one of said interface components (CIG) comprises:
a module for receiving data on the state of the cache and/or the contents of the respective network,
a module for determining whether said contents require an updating or not, and
a module for managing said updating by performing at least one step in the following group comprising:
editing the respective database,
editing the respective Directory Name Service tables,
editing the respective log file archive, and
forwarding an update request message to said at least one similar component.

6. The system according to claim 5 wherein said interface components (CIG) communicate via a CNAP protocol.

7. The interface component (CIG) for implementing Content Delivery Network CDN (CDN1, CDN2) internetworking, the networks (CDN1, CDN2) being comprised in a set and being provided with respective caches, respective Directory Name Service or Domain Name Servers (DNS) and respective content distribution systems to respective clients, said interface component (CIG) being susceptible of being associated to a respective network (CDN1) in said set of networks and co-operating with at least one similar interface component associated to another network (CDN2) in said set of networks, said interface component (CIG) being configured to collect routing data related to the association of said contents and the caches which contain them, said interface component (CIG) comprising:
at least a first interface module (RRI) for exchanging data with said at least one similar component,
a second interface module (DNSI) for interfacing with the Directory Name Service (DNS) of the respective network, and
a core (RRP) for collecting and processing the data received by the component and routing the respective requests, whereby said interface component (CIG) is susceptible of transferring said routing data to the directory name Service or Domain Name Server (DNS) of the respective network via said second interface module (DNSI).

8. The interface component according to claim 7 is configured to be controlled by a monitoring system and comprises:
a third interface module (DII) for retrieving data on the availability of contents from the content distribution system on the respective network, and
a fourth interface module (MII) for interacting with said monitoring system.

9. The interface component according to claim 7 wherein said core (RRP) comprises:
a module for receiving data from said interface modules (RRI, DNSI, DII, MII) and extracting data on the status of the caches and/or of the contents of the respective network therefrom, a module for determining whether said contents require an updating or not, and
a module for managing the updating by performing at least one step in the following group comprising:
editing the respective database,
editing the respective Directory Name Service tables,
editing the respective log file archive, and
forwarding an update request message to said at least one similar interface component.

10. The interface component according to claim 9 said at least a first interface module (RRI) is configured to communicate with a first interface module of said at least one similar component via CNAP protocol.

11. The interface component according to claim 10 wherein said at least a first interface module (RRI) is configured to translate from said CNAP protocol to a format which can be understood by a core (RRP) of said at least one similar interface component.

12. The interface component according to claim 11 said communication between said first interface module (RRI) and a first interface module (RRI) of said at least one similar interface component comprises the transmission of signals indicating quantities from the following group comprising:
ID of the network in which said interface component is associated,
IP address of the computer hosting the local interface component,
IDs of interconnected systems via said interface component and said at least one similar interface component,
IP addresses of the remote interface components of said internetworking systems,
level of confidences of the internetworking network connection, and
at least one identification of physical characteristics, such as the geographical distance of the connection between said interfacing component and said similar interface component.

13. The interface component according to claim 12 wherein said first interface module (RRI) is configured to exchange information with said at least one similar interface component via an IP transportation protocol such as the TCP protocol.

14. The interface component according to claim 12 wherein said core (RRP) and said first interface module (RRI) are configured to exchange signals indicating quantities selected from the following group:
URL identifying the content to which the message refers,
IP address of the cache which distributes the content,
ID of the Content Delivery Network to which the cache belongs,
cache state,
content state in the cache, and
life time of routing data.

15. The interface component according to claim 8 wherein said fourth interface module (MII) is configured to transfer to said core (RRP) signals indicating quantities from the following group comprising:
IP address of the cache to which the message refers,
percentage of CPU used by the cache,
percentage of RAM used by the cache,
percentage of disc used by the cache,
percentage of users connected in relation to the maximum capacity of the involved cache service.

16. The interface component according to claim 8 wherein said third interface module (DII) is configured to send to said core (RRP) signals indicating quantities from the following group comprising:
URL identifying the content to which the message refers,
list of IP addresses of the caches of said content,
level of confidence of said content,
level of availability of said content,
cache state,
life time of routing data.

17. The interface component according to claim 16 wherein said quantity identifying the level of confidence of the content is susceptible of assuming distinct levels corresponding to at least one first level of confidence in the group comprising:
a first level of confidence indicating that the contents may be exchanged by all networks in said set of networks, and
a second level of confidence indicating that the contents may be exchanged on by a selectively determined subset of networks in said set of networks.

18. The interface component according to claim 17 wherein second interface module (DNSI) is configured to communicate with the Directory Name Server (DNS) to update respective tables on the basis of signals indicating quantities from the following group comprising:
ID of the operation to be carried out on the table of said server, such as addition or deletion,
type of register,
name of the domain to which the message refers,
entire URL of the content to which the message refers,
IP address of the best cache to serve said domain, and
life time of the register.

19. The interface component according to claim 18 wherein said core module comprises a memory hosting a data structure containing information on the state of the respective Content Delivery Network and similar internetworking networks.
